(19) United States
(12) Patent Application Publication
(10) Pub. No.: US 2023/0117114 A1
(43) Pub. Date: Apr. 20, 2023

(54) METHOD AND APPARATUS FOR MANAGING A YAML FILE FOR KUBERNETES

(71) Applicant: FOUNDATION OF SOONGSIL UNIVERSITY INDUSTRY COOPERATION, Seoul (KR)

(72) Inventors: Myung Sik YOO, Seoul (KR); Le Van CUONG, Seoul (KR)

(73) Assignee: FOUNDATION OF SOONGSIL UNIVERSITY INDUSTRY COOPERATION, Seoul (KR)

(21) Appl. No.: 17/867,465

(22) Filed: Jul. 18, 2022

(30) Foreign Application Priority Data
Oct. 19, 2021 (KR) 10-2021-0139136

(51) Int. Cl. G06F 40/143; G06F 9/451; G06F 9/50

(52) U.S. Cl. CPC G06F 40/143; G06F 9/451; G06F 9/5077; G06F 2209/505

(57) ABSTRACT

The present subject matter relates to a method and apparatus for managing a YAML file for Kubernetis. According to the present subject matter, the apparatus comprises a front-end component for providing a visual interface to a client, creating a YAML file in accordance with user input through the visual interface, and transforming the generated YAML file into a JavaScript Object Notation (JSON) form; and a back-end component for storing the YAML file transformed into the JSON form in a database, checking, applying and removing the YAML file, and applying the YAML file to a plurality of Kubernetes clusters such that the YAML file is executed.

### CROSS REFERENCE TO RELATED APPLICATION

This application claims under 35 U.S.C. §119(a) the benefit of Korean Patent Application No. 10-2021-0139136 filed on Oct. 19, 2021, the entire contents of which are incorporated herein by reference.

### BACKGROUND

### (A) Technical Field

The present subject matter relates to a method and apparatus for managing a YAML file for Kubernetes.

### (B) Background Art

Kubernetes (K8s) is originally an expandable and transplantable open source system, which is constructed by Google, and is developed and managed by Cloud Native Computing Foundation (CNCF).

When using Kubernetes, it is possible to manage a container in a node cluster. Recently, for several years, big companies such as Google, Facebook, and Neflix have successfully changed from a monolithic architecture to a microservice architecture.

A container is considered a core technology for a microservice architecture.

Kubernetes, one of the best orchestration tools for containers, also supports the implementation of a microservice architecture.

In general, a microservice is deployed as a Pod which is defined as the smallest unit available for deployment by Kubernetes.

It is required to manage and orchestrate a Pod group to provide an application service.

It is difficult to deploy hundreds of or thousands of applications based on a microservice of a cluster.

For this purpose, Kubernetes effectively manage Pods by providing various workload resources explaining the relationship between a microservice and resources assigned to applications such as ReplicaSet, DaemonSet, and StatefulSet.

Workload resources required to deploy applications are described and managed in YAML files. There are existing methods of automatically creating YAML files explaining workload resources, but a management function such as storing, searching for, and correcting Kubernetes YAML files for several users was insufficient.

### SUMMARY OF THE DISCLOSURE

The present subject matter is directed to providing a method and apparatus for managing a YAML file for Kubernetes, the method and apparatus being able to effectively generate, store, retrieve, and correct YAML files required to generate a Kubernetes cluster.

One aspect of the present subject matter provides an apparatus for managing a YAML file for Kubernetes.

The apparatus for managing a YAML file for Kubernetes includes; a front-end component providing a visual interface to a client, creating a YAML file in accordance with user input through the visual interface, and transforming the generated YAML file into a JavaScript Object Notation (JSON) form; and a back-end component storing the YAML file transformed into the JSON form in a database, checking, applying, and removing the YAML file, and applying the YAML file to a plurality of Kubernetes cluster such that the YAML file is executed.

The front-end component may be based on a React framework and the back-end component may be based on an Express framework.

The back-end component may include: a request listener for receiving a request of the front-end component; a render YAML for returning a result received and processed by the request listener to the front-end component; a data processing unit for storing the YAML file in the database; and a K8s interaction checking, applying and removing the YAML file for the plurality of Kubernetes clusters.

The back-end component may retrieve and transform a JSON file requested to be searched into a YAML file when a user request searching of a YAML file, and the front-end component may display the transformed YAML file on a GUI such that a user generates a new YAML file, check whether the new YAML file can be correctly operated using a kubectl command line tool, and apply the new YAML to a corresponding Kubernetes cluster.

Another aspect of the present subject matter provides a method of managing a YAML file for Kubernetes.

The method of managing a YAML file for Kubernetes includes: a step in which a front-end component provides a visual interface to a client and generates a YAML file in accordance with user input through the visual interface; a step in which the front-end component transforms the generated YAML file into a JavaScript Object Notation (JSON) form; a step in which a back-end component stores the YAML file transformed into the JSON form in a database; a step in which the back-end component checks, applies, and removes the YAML file; and a step in which the back-end component applies the YAML file to a plurality of Kubernetes cluster such that the YAML file is executed.

### BRIEF DESCRIPTION OF THE DRAWINGS

FIG. 1 shows an example of a YAML filer for a Kubernetes deployment workload resource.

FIG. 2 is a diagram showing an architecture for managing a YAML file for Kubernetes according to a preferred embodiment of the present subject matter.

FIG. 3 is a diagram showing a workflow for generating a YAML file according to the present embodiment.

FIG. 4 is a diagram showing a workflow for searching for and correcting a YAML file according to the present embodiment.

### DETAILED DESCRIPTION

The present subject matter may be modified in various ways and implemented by various exemplary embodiments, so that specific exemplary embodiments are shown in the drawings and will be described in detail.

However, it is to be understood that the present subject matter is not limited to the specific exemplary embodiments, and includes all modifications, equivalents, and substitutions included in the spirit and the scope of the present subject matter.

Hereafter, a Kubernetes system is briefly described before describing an architecture for managing a YAML file for Kubernetes according to the present embodiment.

Kubernetes, which is a declarative system, performs the work required for making and maintaining a desired state in accordance with time instead of executing a series of commands, and determines this state into a resource group having a configurable property explained in a YAML file.

In Kubernetes, a Pod is the most fundamental deployment unit, and a workload resource manages executing, copying, and monitoring of Pods in a Kubernetes cluster.

Kubernetes provides various types of workload resources as follows.

ReplicaSet is a group of various Pods that can be replaced, if necessary, and is used to manage non-stateful applications. Using this makes it possible to set the number of application copies, and when the number of copies that are being deployed is changed, the number of copies of applications in a cluster is changed.

Kubernetes reserves and generates a new container when the number of copies that are being executed is smaller than a necessary number, and finishes a container until the number of containers satisfies the number of copies, on the contrary, when the number of copies that are being executed is larger than a necessary number.

StatefulSet is used to manage stateful applications that execute one or more relevant Pods.

DaemonSet defines a pod that provides a node local function. When a new node coinciding with the specification of DaemonSet is added to a cluster, Kube-scheduler reserves a Pod for DaemonSet into the new node.

Job and CronJob define work that stops after being executed until finishing. CronJob periodically repeats work in accordance with a given schedule. Work generates a Pod set and keeps reattempting to execute a Pod until a designated number of Pods are successfully finished.

A YAML file, which is a markup language, is a data serialization language that is usually used to construct configuration files.

A YAML file is made for object continuity, a log file, inter-process messaging, a configuration file, etc. and has an advantage that it is easily implemented and can be expanded.

The building blocks of a YAML file are described as follows.
Key-Value Pair: Fundamental item type of YAML file
Dictionary/Map: More complicated type of YAML file
Arrays/Lists: Several items are arranged under list names in a list

The desired state should be explained when creating a workload resource in Kubernetes.

Kubernetes can crate workload resources directly using API, but it may be actually considerably complicated. In general, a desired state of a workload resource is explained in a YAML file. A workload resource of Kubernetes generates a Pod using the information of a YAML file and checks whether a Pod that is being executed coincides with the desired state of a YAML file.

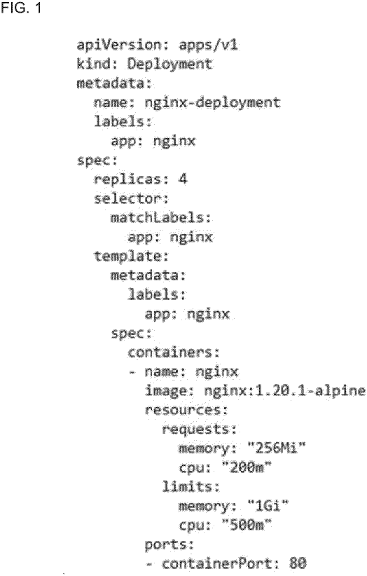

FIG. 1 shows an example of a YAML filer for a Kubernetes deployment workload resource.

In FIG. 1, a deployment workload resource called nginx-deployment having four copied Pod were generated.

A Pod to be managed is found out using a spec.selector field, and there are lower fields such as a Pod label and a Pod template specification in a template field.

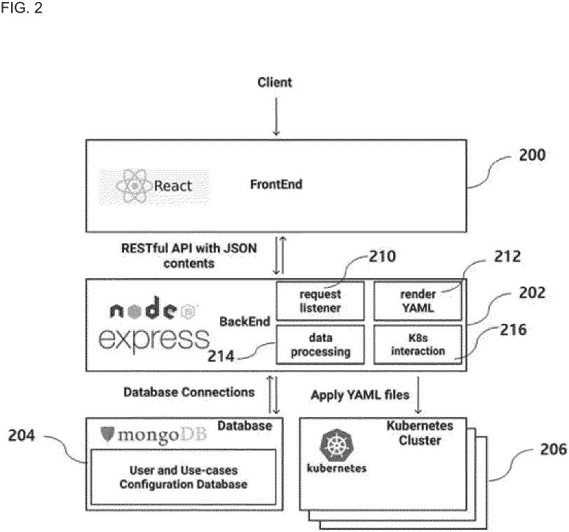

FIG. 2 is a diagram showing an architecture for managing a YAML file for Kubernetes according to a preferred embodiment of the present subject matter.

As shown in FIG. 2, an architecture according to the present embodiment may include a front-end component 200, a back-end component 202, a database 204, and a Kubernetes cluster 206.

The architecture relates to a management application of a YAML file for Kubernetes, and the front-end component 200 is based on a React framework.

According to the present embodiment, the front-end component 200 provides a visual interface GUI to a client and generates a YAML file in accordance with the input of a user.

According to the present embodiment, a YAML file generated by the input of a user is transmitted to the back-end component 202 in the form of JavaScript Object Notation (JSON).

The back-end component 202 according to the present embodiment is based on an Express framework.

The back-end component 202 may include a request listener 210, a render YAML 212, a data processing unit 214, and a K8s interaction 216.

The request listener 210 stands to process request data of the front-end component 200.

The render YAML 212 returns the result processed by the request listener 210 to the front-end component 100.

The data processing unit 214 manages data using database 204, and the data are stored in the form of JSON.

The K8s interaction 216 makes each of a plurality of Kubernetes clusters 206 installed thereunder apply and execute a YAML file.

The K8s interaction 216 is used to check, apply, and remove YAML files in a plurality of Kubernetes clusters 206, and easily interacts with the Kubernetes cluster 206 by integrating kubectl, a Kubernetes command line tool, and many Kubernetes configurations.

The database 204 may be a MongoDB, which is a Non-SQL database, and stores YAML files in the form of JSON.

The YALM files stored in the database 204 may be used to be quickly adapted to new deployment requests of application programs in the data processing unit 214.

In order to manage YALM files, it is required to manage a plurality of Kubernetes clusters for several clients. A YAML file explains a workload resource that can be used in all environments through slight correction. The workflow of the present embodiment provides a mechanism that effectively and stably generates, stores, and reuses YAML files.

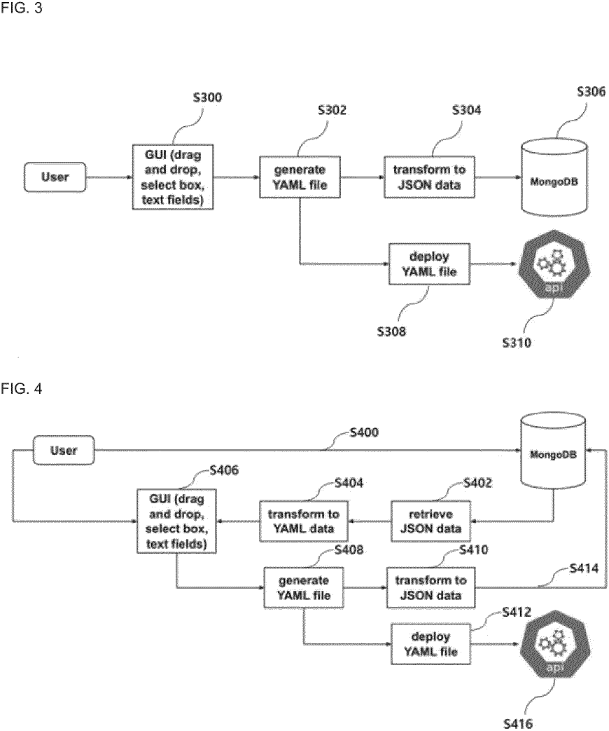

FIG. 3 is a diagram showing a workflow for generating a YAML file according to the present embodiment.

Referring to FIG. 3, the front-end component 200 provides a GUI that is a visual interface to a user (step 300). The user can perform drag, drop, box selection, and text input through the GUI.

Thereafter, a YAML file is generated in accordance with the input of the user (step 302).

Since YAML file is difficult to store, a workload resource is transformed into the form of JSON (step 304), and then stored in the database 204 (step 306).

Further, the K8s interaction 216 of the back-end component 202 checks limitation conditions and sentences of the YAML file generated in step 302 through a kubectl command line tool (step 308), and executes the YAML file by applying it to corresponding Kubernetes cluster 206.

The kubectl command line tool is a fundamental tool provided in Kubernetes and enables a user to easily control the Kubernetes cluster 206.

FIG. 4 is a diagram showing a workflow for searching for and correcting a YAML file according to the present embodiment.

Referring to FIG. 4, when a user gives a request for searching for a YAML file stored in the form of JSON in the database 204 (step 400), the JSON file requested to be searched is searched (step 402) and the searched JSON file is transformed into a YAML file (step 404).

Steps 400 to 404 may be performed in the back-end component 202.

The YAML file transformed in step 404 is displayed on the GUI (step 406) and the user generates a new YAML file by correcting the existing YAML file under a given condition (step 408).

The newly generated YAML file is transformed into the form of JSON (step 410) and is stored in the database 104 (step 412).

Steps 406 to 410 may be performed in the front-end component 200.

Simultaneously, whether the newly generated YAML file can be correctly operated is checked using the kubectl command line tool (step 414).

Thereafter, the K8s interaction 216 executes the newly generated YAML file by applying it to a corresponding Kubernetes cluster 106 (step 416).

Management of a YAML file for Kubernetes according to the present embodiment may be performed in a device including a processor and a memory.

The processor may include a central processing unit (CPU) that can execute computer programs or other virtual machines.

The memory may include a nonvolatile storage device such as a fixed-type hard drive or a detachable storage device. The detachable storage device may include a compact flash unit, a USB memory stick, etc. The memory may include a volatile memory such as various random access memories.

According to an embodiment of the present subject matter, program instructions for management of a YAML file for Kubernetes are stored in memory, and the program instructions according to the present embodiment perform the processes of FIGS. 3 to 4.

According to the present subject matter, there is an advantage that it is possible to conveniently generate, store, retrieve, and correct a YAML file through a front-end component and a back-end component.

The above embodiments of the present subject matter are provided for examples, various changes, modifications, and additions may be possible within the spirit and scope of the present subject matter by those skilled in the art, and those changes, modifications, and additions should be construed as being included in the following claims.

1. An apparatus for managing a YAML file for Kubernetes comprising:
a front-end component for providing a visual interface to a client, generating a YAML file in accordance with a user input through the visual interface, and transforming the generated YAML file into a JavaScript Object Notation (JSON) form; and
a back-end component for storing the YAML file transformed into the JSON form in a database, checking, applying and removing the YAML file, and applying the YAML file to a plurality of Kubernetes clusters such that the YAML file is executed,
wherein the back-end component, in response to a user’s request for retrieving a YAML file, retrieves and transforms a corresponding JSON file into a YAML file, and
the front-end component displays the transformed YAML file on a GUI such that a user generates a new YAML file, checks whether the new YAML file can be correctly operated using a kubectl command line tool, and applies the new YAML to a corresponding Kubernetes cluster.

2. The apparatus of claim 1, wherein the front-end component is based on a React framework, and
wherein the back-end component is based on an Express framework.

3. The apparatus of claim 1, wherein the back-end component includes:
a request listener for receiving and processing a request of the front-end component;
a render YAML for returning a result of processing the received request to the front-end component;
a data processing unit for storing the YAML file in the database; and
a K8s interaction for checking, applying and removing the YAML file for the plurality of Kubernetes clusters.

4. (canceled)

5. A method for managing a YAML file for Kubernetes comprising:
providing a visual interface to a client and generating a YAML file in accordance with a user input through the visual interface by a front-end component;
transforming the generated YAML file into a JavaScript Object Notation (JSON) form by the front-end component;
storing the YAML file transformed into the JSON form in a database by a back-end component;
checking, applying and removing the YAML file by the back-end component;
applying the YAML file to a plurality of Kubernetes clusters to execute the YAML file by the back-end component;
in response to a user’s request for retrieving a YAML file, retrieving and transforming a corresponding JSON file into a YAML file by the back-end component; and
displaying the transformed YAML file on a GUI such that a user generates a new YAML file, checking whether the new YAML file can be correctly operated using a kubectl command line tool, and applying the new YAML to a corresponding Kubernetes cluster by the front-end component.

6. The method of claim 5, wherein the front-end component is based on a React framework,
wherein the back-end component is based on an Express framework.

7. The method of claim 5 further comprises:
receiving a request of the front-end component by the back-end component;
processing the request and returning a result to the front-end component by the back-end component;
storing the YAML file in a database by the back-end component; and
checking, applying, and removing the YAML file for the plurality of Kubernetes clusters by the back-end component.

8. The apparatus of claim 3, wherein the database is a Non-SQL database,
wherein the YAML file stored in the database is used to be quickly adapted to new deployment requests of application programs in the data processing unit.

9. (canceled)

10. The method of claim 7, wherein the database is a Non-SQL database,
wherein the YAML file stored in the database is used to be quickly adapted to new deployment requests of application programs.

11. A non-transitory computer-readable storage medium storing one or more instructions that, when executed by a system for managing a YAML file for Kubernetes, cause one or more components of the system to perform operations comprising:
providing a visual interface to a client and generating a YAML file in accordance with a user input through the visual interface;
transforming the generated YAML file into a JavaScript Object Notation (JSON) form;
storing the YAML file transformed into the JSON form in a database;
checking, applying and removing the YAML file;
applying the YAML file to a plurality of Kubernetes clusters to execute the YAML file;
in response to a user’s request for retrieving a YAML file, retrieving and transforming a corresponding JSON file into a YAML file; and
displaying the transformed YAML file on a GUI such that a user generates a new YAML file, checking whether the new YAML file can be correctly operated using a kubectl command line tool, and applying the new YAML to a corresponding Kubernetes cluster.
